(19) United States
(12) Patent Application Publication
(10) Pub. No.: US 2008/0282138 A1
(43) Pub. Date: Nov. 13, 2008

(54) METHODS AND SYSTEMS FOR MULTIMEDIA OBJECT ASSOCIATION TO DIGITAL PAPER SPATIAL DIAGRAMS

(76) Inventors: Paulo Barthelmess, Renton, WA (US); David McGee, Bainbridge Island, WA (US); Alex A. Arthur, Seattle, WA (US); David Scott, Port Orchard, WA (US); Erik M. Erikson, Seattle, WA (US); R. Matthews Wesson, Portland, OR (US); Ira Smith, Seattle, WA (US); Phil Cohen, Bainbridge Island, WA (US); Philipp Schmid, Mercer Island, WA (US); Michael Robin, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 12/131,852

(22) Filed: Jun. 2, 2008

Related U.S. Application Data
(63) Continuation-in-part of application No. 12/118,656, filed on May 9, 2008.
(60) Provisional application No. 60/941,332, filed on Jun. 1, 2007.
(60) Provisional application No. 60/917,034, filed on May 9, 2007.
(60) Provisional application No. 60/969,552, filed on Aug. 31, 2007.
(60) Provisional application No. 61/028,498, filed on Feb. 13, 2008.

(51) Int. Cl. G06F 17/00

(52) U.S. Cl. 715/201

(57) ABSTRACT

Methods and systems for multimedia object association to digital paper spatial diagrams are disclosed herein. A method for multimedia object association to digital paper spatial diagrams includes the steps of (1) capturing a media object to be imported into a spatial information system; (2) linking the captured media object to a digital paper document containing a spatial diagram, using a input device configured to select a linking action area located in a first area of the digital paper document and configured to select a location for the captured multimedia data object on a second area of the digital paper document; (3) transferring the media object and the data from the input device to a spatial information system; and (4) combining the media object and the data of the input device to create an updated digital paper document containing the media object.

### PRIORITY CLAIM

This application claims priority to U.S. Provisional Patent Application Nos. 60/941,332 (filed on Jun. 1, 2007) and is a continuation-in-part of U.S. patent application Ser. No. 12/118,656 (filed on May 9, 2008) which claims priority to U.S. Provisional Patent Application Nos. 60/917,034 (filed on May 9, 2007), 60/969,552 (filed on Aug. 31, 2007), 61/028,498 (filed on Feb. 13, 2008), the subject matter of each are incorporated herein by reference in their entirety.

### BACKGROUND OF THE INVENTION

Today field markup and data collection is typically done on paper, sometimes with supporting check box inspection lists but usually still on paper. Seldom is the support or benefits of digital technology available in practical and usable tools. Field personnel have frequently found their needs frustrated by the fragility or inadequacy of information technology applied to their work. Even normal conditions, like bright sunlight, let alone austere weather or environment conditions generally preclude the use of computational devices. Rugged laptops are heavy and in most cases cannot be comfortably operated in the field. Smaller portable devices (PDAs) provide very limited screen real-state, and may not be rugged enough in many situations.

Commonly field collection is related to spatial information systems which are printed as spatial diagrams such as blueprints, map or other field reference products. However, data collection does not solely include spatial information systems but also may include user notes in a journal, photographs, dictation and/or video of the location. Currently notes taken in the journal are not linked to photographs, which are further not linked to the spatial diagram they correspond to.

A digital paper system includes an input device such as a touch board, a microphone, a keyboard, a digital ink tablet, and a projector, a writing surface and a writing utensil in which the utensil knows its location in real time when it is marking on the surface. The writing surface may take the form of a digital tablet or digital paper, for example digital paper made by the Anoto Group AB and having an ANOTO® pattern. Various types of conventional digital pens include, but are not limited to, the MAXELL® digital pen, the NOKIA® digital pen, the LEAPFROG FLYFUSION® digital pen, the ANOTO® digital pen, the LIVESCRIBE® PULSE smart pen, and the LOGITECH® digital pen. Besides knowledge of placement location, some digital paper systems also maintain records of information like pressure or time as well as various “state” values such as color or width. Further input devices may combined in order to facilitate multi-modal interaction within the computer system. A human operator can issue instructions and provide information via microphone and keyboard. The operator can receive information via the audio speaker. A projector projects images on the map that are visible to the operator.

### SUMMARY OF THE INVENTION

Methods and systems for multimedia object association to digital paper spatial diagrams are disclosed herein. A method for multimedia object association to digital paper spatial diagrams includes the steps of (1) capturing a media object to be imported into a spatial information system; (2) linking the captured media object to a digital paper document containing a spatial diagram, using a input device configured to select a linking action area located in a first area of the digital paper document and configured to select a location for the captured multimedia data object on a second area of the digital paper document; (3) transferring the media object and the data from the input device to a spatial information system; and (4) combining the media object and the data of the input device to create an updated digital paper document containing the media object.

### BRIEF DESCRIPTION OF THE DRAWINGS

The preferred and alternative embodiments of the present invention are described in detail below with reference to the following drawings.

FIG. 1 shows an example method for multimedia object association to digital paper spatial diagrams; and

FIG. 2 shows an example system for multimedia object association to digital paper spatial diagrams.

### DETAILED DESCRIPTION OF THE PREFERRED EMBODIMENT

In the following description, certain specific details are set forth in order to provide a thorough understanding of various embodiments of the invention. However, one skilled in the art will understand that the invention may be practiced without these details or with various combinations of these details. In other instances, well-known systems and methods associated with, but not necessarily limited to, spatial information systems, digital paper systems, digital pens and methods for operating the same may not be shown or described in detail to avoid unnecessarily obscuring descriptions of the embodiments of the invention.

The present invention is generally directed to linking data from a multimedia capture device such as a photos, videos, audio, and tags to a digital paper-enabled product for digital data collection using digital paper systems, such as maps, blueprints, diagrams, CAD drawings, and other documents having spatially relevant information printed or applied thereon. The digital paper-enabled product allows a user to create, import, edit, share, and act on paper-based data in and between spatial information systems. In one embodiment the plurality of media objects are associated with particular locations in a spatial information system. For example a note written with a digital pen within a digital paper enabled notebook is linked with a particular location on a digital-enabled product containing a map, sometimes called a spatial diagram.

At least one embodiment of the present invention relates generally to linking a media object with a digital paper-enabled product having digital paper with a digital pattern that spatially cooperates with one or more features or boundaries printed on the pattern, and more specifically to spatial information systems that communicate with a writing instrument previously used to effect changes to the digital paper-enabled product and communicate with a multimedia device used to capture a media object. The spatial information system further combines the media object with the selected location within the digital paper-enabled document. In one embodiment of its product form, the digital paper-enabled product may take the form of a sheet of digital paper bearing a digital pattern and where features (e.g., such as map features) or a spatial reference frame printed onto the digital pattern and where at least one action palette is printed onto the digital pattern, correlated therewith, and usable to effect changes to the features and to link media objects with the digital paper-enabled product. In alternate embodiments, the at least one action palette may be printed onto a separate digital paper-enabled product having a digital pattern. By way of example, a user may take a picture of an area shown on the digital paper-enabled product, then the user may use a writing instrument or indication device, such as a digital pen, to link the picture to the document through executable actions produced by interaction of the writing instrument with the digital paper-enabled product.

In yet another aspect of the invention, a method of processing information obtained from a digital paper-enabled product and capture device includes (1) receiving information with a input device that indicated a link of at least one media object to the digital paper-enabled product, the at least one media object correlated to a location on the digital paper; (2) placing the input device in communication with a spatial information system configured to manage the at least one media object link; (3) transferring the information from the input device to the spatial information system to update the linked media object within the spatial information system; (4) capturing the linked media object from a capture device; and (5) synchronizing the spatial information system to generate an updated version of the digital paper-enabled product.

And still yet in another aspect of the invention, a method of using a digital paper-enabled product when de-coupled from a spatial information system includes the steps of (1) accessing the digital paper-enabled product having a sheet of digital paper bearing a digital pattern and having at least one identifiable region spatially correlated to the digital pattern with a coordinate system; (2) indicating on the product linking action causing a media object to be linked to a spatial information system; and (3) recording the linking action with an indicating device.

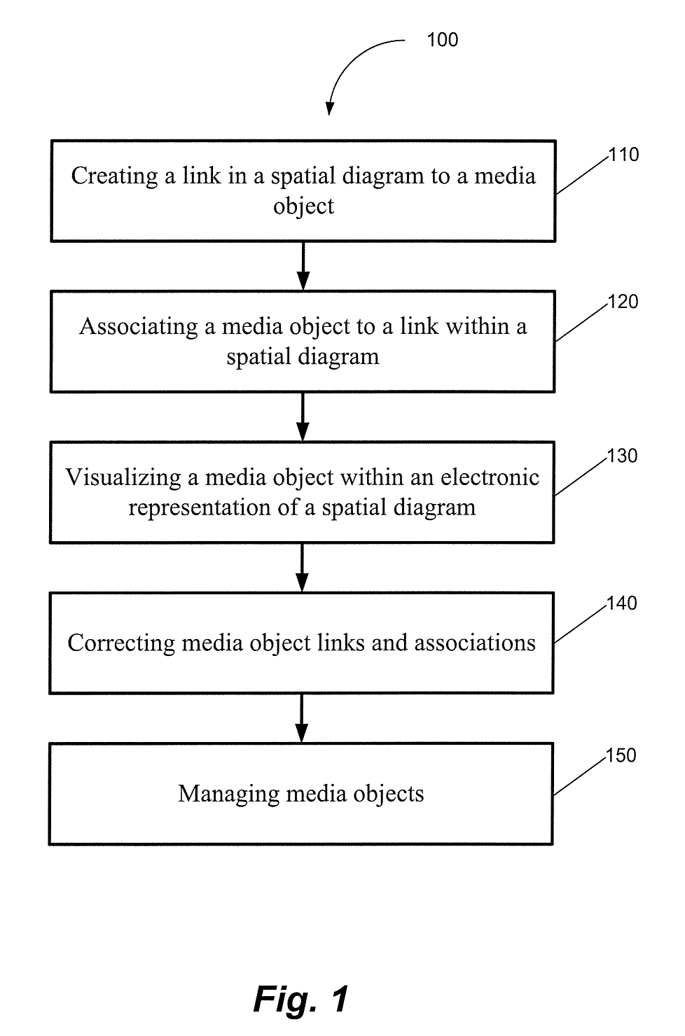

FIG. 1 shows an example method 100 for multimedia object association to digital paper spatial diagrams. At block 110 a link is created in a spatial diagram to a media object. The link refers to an indication of the desire to connect or anchor a media object such as a note, photo, video, or (barcode) tag to a specific location of a spatial diagram, or to a specific object (for example a wall or a window on an architectural drawing) represented within the diagram. In one embodiment linking is activated by an explicit activation of an interface action, for example by ticking a checkbox in an action palette, such as “Add note”, “Add photo”, “Add Media Link”, followed by a selection gesture indicating the location in the special diagram. The selection may consist of any number of strokes in the location onto which the media object is to be linked to, or a selection gesture (checkmark, lasso) on a specific object (such as a wall or window) to which the media object is linked to. In an alternate embodiment linking is activated by sketching a symbol representing a link on the region of the media object is to be linked to or on a specific object to which the media object is to be linked to. The symbol may include identifiers (such as numbers or names) that are used during the association of media objects to links; identifiers are described in more detail in reference to block 120. In yet another alternate embodiment linking is activated by leveraging locational information that may be embedded in the media object.

At block 120 a media object is associated to a link within the spatial diagram. Association refers to the means by which specific media objects are connected to individual links. One or more media objects may be associated with any link. Conversely, only a subset of the media objects that have been collected may be associated to drawing links. For example pages of notes, some of which, are associated with locations in a spatial diagrams others are not. In one embodiment associations can be established by an explicit selection of a user interface action on the media object, for example by ticking a checkbox on a note page indicating it is to be associated with a link, or selecting an association interface option on a capture device such as a camera or similar device. In an alternate embodiment, associations can be established by using timestamps to associate media objects captured on the temporal vicinity of a linking action, for example by associating with a link those objects whose timestamps fall within plus/minus seconds of the linking action. In yet another alternate embodiment, associations can be established by using identifiers, such as photo or page numbers that are matched to identifiers specified in the linking symbol. In yet another alternate embodiment, associations can be established by location information that may be embedded in the media object, for example GPS location embedded in a photo. The association in this case preferably corresponds to the automatically created link location. In an alternate embodiment linking may occur using a gesture, a voice command, or a multi-modal instruction.

At block 130 the media object is visualized within an electronic representation of a spatial diagram. For example after a user has retrieved the media object from the media device into a computer a user can see the media object on the spatial diagram. In one embodiment linked and/or associated media objects may be presented on an electronic representation of a spatial diagram as icons or thumbnails. A selection action causes the associated media object to be displayed. In an alternate embodiment an electronic representation of a media object, such as the note or photo, a user interface action causes the spatial diagram location to which the media object is associated to be displayed.

At block 140 media object links and associations are corrected. In one embodiment media object links are corrected on an electronic representation of a spatial diagram. The corrections include, but are not limited to deleting a link, inserting a new link, changing the association between links and media objects. This review may take place within an electronic editing environment or in some embodiments can be performed with a digital pen on digital paper printouts of the spatial diagram and associated media object representations such as printout of note pages, photos or representative images of movies.

At block 150 media objects are managed. Media objects associated to links in a spatial diagram may be stored in separate memory areas, in which case the correlation between object and diagram is represented as connection meta-data, or the media objects may be inserted into the same file as the spatial diagram. A media object that is inserted into the same file as the spatial diagram is self contained and can be conveniently transported via email, or other electronic means as a unit. In one embodiment, object management includes retrieving from the capture devices such as a digital pen or a camera only those objects that have been associated to links to one or more spatial diagrams. For example, photos that are not associated to any link remain in the capture device; similarly, only the electronic ink pertaining to note pages that have been associated to links is removed from the digital pen, and others remain. In one embodiment removal is achieved either by selective removal, when the capture device supports this function or by fully removing and then reinserting those objects that have not been associated with links.

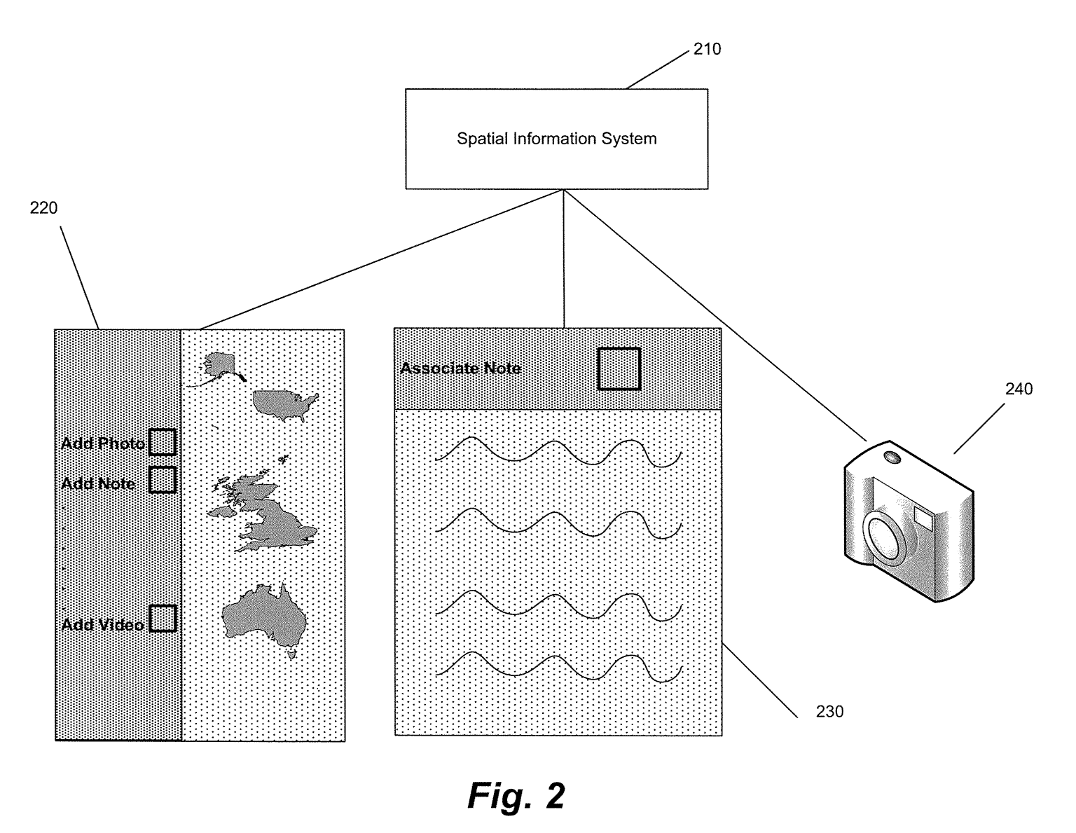

FIG. 2 shows an example system for multimedia object association to digital paper spatial diagrams. A spatial information system 210 takes the form of computational processing device, such as a computing device, which may be, but is not limited to, a personal, mainframe, handheld, or other type of computer with sufficient memory and computing capacity to process the data. The data, in turn, may digitally define features, icons, graphical elements, symbols, characters, indicia, mathematical or computational elements, or any other feature (hereinafter generally referred to as feature or features) that may be used to represent some portion of a map, blueprint, drawing, photo, image, diagram, or other document. The spatial information system is in communication with a spatial diagram 220 printed on digital paper through a digital pen (not shown). The spatial information system 210 is in data communication with a plurality of capture devices containing media objects, such but not limited to as a note 230 written on digital paper and transmitted to the spatial information system 210 using a digital pen and a camera 240. For example, a linking action in the spatial diagram 220 correlated with an associating action in at least one of a note 230 or a photo from a camera 240 results in a media object being linked to the spatial diagram 220 in the spatial information system 210.

By way of an example and generally referring to FIG. 2, a capture device such as a camera 240 takes a picture of a wall shown in the spatial diagram 220. On the camera 240 a user selects an icon that associates the picture of the wall to the spatial diagram 220. Using a digital pen, the user selects a link icon within the spatial diagram 220 and then selects the wall in the spatial diagram 220 using a lasso motion. The user then goes to a spatial information system 210 where when the digital pen and camera 240 are linked to the system 210 the photo of the wall is placed as an icon at the location of the wall in the spatial diagram. Therefore allowing a user to see the wall as represented by the diagram 220 and by selecting the object sees the photograph of the wall. Advantageously this link allows the photo of the wall to be directly linked to the location on the diagram therefore advantageously providing organization and more detail to the diagram 220.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A method for multimedia object association to digital paper spatial diagrams comprising:
capturing a multimedia data object containing digital data to be imported into a spatial information system;
linking the captured multimedia data object to a digital paper document containing a spatial diagram, using a input device configured to activate a linking action area located in a first area of the digital paper document and configured to select a location for the captured multimedia data object on a second area of the digital paper document;
transferring the multimedia data object and the data of the input device containing the linking action and the location for the multimedia data object on the digital paper document to a spatial information system;
combining the multimedia data object and the data of the input device to create an updated digital paper document containing the multimedia data object.

2. The method of claim 1, wherein the multimedia data object is a digital photograph.

3. The method of claim 1, wherein the multimedia data object is digital data from a second physical document.

4. The method of claim 1, wherein the multimedia data object is an audio recording.

5. The method of claim 1, wherein the multimedia data object is a video recording.

6. The method of claim 1, wherein the multimedia data object is a barcode tag.

7. A method for multimedia object association to digital paper spatial diagrams comprising:
activating at least one linking icon within an action palette, which includes a first coordinate system co-operable with a digital pattern carried by a document, the at least one link icon manageable by a spatial information system and having a spatial relationship to at least one other feature managed by the spatial information system;
selecting a location for a media object within a spatial reference frame having a second coordinate system co-operable with the digital pattern carried by the document;
applying the action palette onto the digital pattern of the document, wherein the at least one link icon becomes spatially determinable using the first coordinate system in conjunction with the digital pattern;
associating the media object with the spatial information system by selecting an association icon within the media object; and
linking the media object to the spatial information system at the selected location within the document.

8. The method of claim 7, wherein the multimedia object is a digital photograph.

9. The method of claim 7, wherein the multimedia object is digital data from a second physical document.

10. The method of claim 7, wherein the multimedia object is an audio recording.

11. The method of claim 7, wherein the multimedia object is a video recording.

12. The method of claim 7, wherein the multimedia object is a barcode tag.

13. A method for multimedia object association to digital paper spatial diagrams comprising:
receiving information with a input device that indicated an association action of at least one object of a first digital paper-enabled product, the at least one object having digital data associated therewith and correlated to a digital pattern on digital paper;
receiving information with a input device that indicated a link action by selection of at least one feature of a second digital paper-enabled product, the at least one feature having a link property associated therewith and correlated to a location within the digital pattern on digital paper;
transferring the digital data associated with the first digital paper-enabled product and the location of the at least one feature on the second digital paper-enabled product to a spatial information system; and
synchronizing the spatial information system to generate an updated version of the second digital paper-enabled product to include the digital data associated with the first digital paper-enabled product.

14. The method of claim 13, wherein the digital data is a digital photograph.

15. The method of claim 13, wherein the digital data is digital data from a second physical document.

16. The method of claim 13, wherein the digital data is an audio recording.

17. The method of claim 13, wherein the digital data is a video recording.

18. The method of claim 13, wherein the digital data is a barcode tag.

19. A data collection system comprising:
at least one capture device configured to produce a media object;
a spatial diagram comprising a physical document bearing a digital pattern and having at least one identifiable region spatially correlated to the digital pattern using a first coordinate system;
an input device configured to generate a link action with respect to a media object;
a spatial management system configured to place the captured media object on the spatial diagram in the location selected during the link action.

20. The system of claim 19, wherein an input device is an action palette overlaid onto and spatially correlated to the digital pattern using a second coordinate system, the action palette having at least one symbol that is selectable by a writing instrument to generate a link action with respect to a media object.

21. The system of claim 19, wherein the multimedia object is a digital photograph.

22. The system of claim 19, wherein the multimedia object is digital data from a second physical document.

23. The system of claim 19, wherein the multimedia object is an audio recording.

24. The system of claim 19, wherein the multimedia object is a video recording.

25. The system of claim 19, wherein the multimedia object is a barcode tag.
